(19) United States
(12) Patent Application Publication
(10) Pub. No.: US 2011/0147452 A1
(43) Pub. Date: Jun. 23, 2011

(54) PAYMENT SYSTEM

(75) Inventor: Ming-Chiao HO, Jhonghe City (TW)

(73) Assignee: DOTOP TECHNOLOGY, INC., Jhonghe City (TW)

(21) Appl. No.: 12/646,620

(22) Filed: Dec. 23, 2009

(51) Int. Cl. G06K 5/00

(52) U.S. Cl. 235/380

(57) ABSTRACT

A payment system for paying money in the Internet is provided. The system includes an IC card, wherein the IC card has a circuit for transforming a signal into a USB signal and a USB interface; a USB port of a computer, wherein the USB interface of the IC card communicates with the USB port; a front-end trade platform, the IC card communicates with the front-end trade platform through the computer and the Internet; and a back-end trade platform, wherein the back-end trade platform has a program to perform a small amount of money payment process that does not perform an identification process to identify a holder of IC card.

### BACKGROUND

1. Field of Invention

The present invention relates to a payment system. More particularly, the present invention relates to a payment system that uses an IC card (Integrated Circuit Card) with an USB interface to trade over the Internet.

2. Description of Related Art

Typically, three types of IC card, a contactless type Card, a contact type card and a combo-type card, can be used in a payment system.

When using the contact type card to pay money, the contact type card is inserted into a reading card machine to read the integrated circuit in the card to process the payment data. For security, a special identification process is also used to identify the data stored in the card. Typically, credit card and banking card are contact type card.

The contactless type Card has an integrated circuit connected with an inductance coil. The integrated circuit is activated by electromagnetic induction. That is, an induction region is built in a reading card machine to induct the inductance coil to activate the integrated circuit to read data stored in the contactless type card. Typically, the induction speed is quick. Therefore, the contactless type card is usually used in an entrance guard system, such as an entrance guard of a rapid transit system.

The combo card has the functions of both the contactless type card and the contact type card. That is, the IC of the combo card can be read by inserting the combo card into a reading card machine or by electromagnetic induction.

A special reading card machine is required to read the data in the IC of the above three types of IC card. FIG. 1 illustrates a schematic diagram of reading a contact type banking card and reading a contactless type banking card. The contact type banking card 11 is inserted into a reading card machine 12 to read the data in the IC. A reading card machine 14 has an induction region to induct the inductance coil to read data stored in the contactless type banking card 13. Both the reading card machine 12 and 14 are connected to a computer 15. The data stored in the IC of the contact type banking card 11 is transferred to the computer 15 through the reading card machine 12 to trade. The data stored in the IC of the contactless type banking card 13 is transferred to the computer 15 through the reading card machine 14 is to trade.

Trading over the Internet is common now. However, because a user may have a contactless type Card and a contact type card, he needs to prepare two different reading card machines for reading these two types of card if he wants to use two types of cards to trade, which increases trade cost. Moreover, no matter what the amount of money, same complicated identification process and password are used to identify the data stored in the card. Such complicated identification process reduces the usage of a user to use a card to pay money when the mount of money is small. On the other hand, it is impossible to integrate the payment system and user interface, which also reduces the desire of the user to use the cards to pay money over the Internet when the amount of money is small.

### SUMMARY

The present invention provides a system for resolving the above problems.

According to the present invention, a USB circuit and a USB interface are integrated into a card. The card includes a contactless type Card, a contact type card and a combo-type card. The USB interface protrudes out the card to be inserted into a USB port in a computer. Or, the USB interface is formed in the card. A wire is used to connect the card to the USB port of the computer. Such a card structure can directly communicate with the computer. Therefore, the reading card machine is not necessary. Moreover, the complicated identification process is removed by increasing the pre-paid function and a deducting the money function in a trade platform. Such simplifying payment process provides the user to pay a small amount of money.

According to another embodiment, the present invention provides an apparatus having a circuit and a USB interface, a buyer management module of a website (or called front-end trade platform), the Internet, a banking server and a trade module (or called back-end trade platform). The circuit includes a memory logic gate storing pre-paid data and deducting money data. The circuit and the USB interface are covered by a shell. The USB interface can be inserted into a USB port of a computer to communicate with the computer. A buyer can connect with a web-site through the Internet to buy goods and pay money. Moreover, after paying money, the buyer can communicate with a buyer management module of this website (or called front-end trade platform) to detect the pre-paid data and deducting money data of the user.

As long as the USB interface is a standard size, the appearance and size of the shell can be varied. Therefore, the shell can be designed to satisfy different requirements. That is, such a card with a USB interface can be used as cash in a simplifying payment process whose identification process is removed to provide the user to pay a small amount of money. Such a card with a USB interface can be used over the Internet to pay a small amounts of money. Moreover, Such cards with a USB interface also can be used as an electrical gift coupons.

Accordingly, the present invention has the following advantages.

The present invention builds a USB interface and a memory circuit in a card, and provides a pre-paid function and a simplifying payment process in a back-end trade platform for the user to pay a small amount of money. According is to the claimed invention, when a card is fabricated, the USB interface is embedded in this card to enable this card to directly communicate with a computer. And, a program for processing a small amount of money payment is embedded in the IC of the card to cooperate with a simplifying payment process whose identification process is removed in a back-end trade platform. Therefore, the card can be used as a payment tool in the Internet. Such a card increases the usage convenience and provides a tool to process a small amount of money payment over the Internet.

Moreover, according to the present invention, a USB interface can be integrated into a card. The USB interface can make the card directly communicate with the computer to trade over the Internet. Therefore, the reading card machine is not necessary. In other words, the reading card machine cost is saved. On the other hand, the USB interface does not affected the original function of the card.

Moreover, the card with a USB interface can be used as cash in simplifying the payment process whose identification process is removed to provide the user a similar way to pay a small amount of money over the Internet. Therefore, it is very convenient for a user to use this card to trade in Internet.

Moreover, the appearance and size of the card cane be varied. Therefore, the card can be designed to satisfy different requirement or to to increase the convenience for brining this card. Because the card has a USB interface, the user can utilize this card to trade over the Internet in anywhere as long as there is a computer. Such advantage can make this card to serve as an electrical gift coupon.

### BRIEF DESCRIPTION OF THE DRAWINGS

The invention can be more fully understood by reading the following detailed description of the embodiments, with reference made to the accompanying drawings as follows:

FIG. 1 illustrates a schematic diagram of reading a contact type banking card and reading a contactless type banking card.

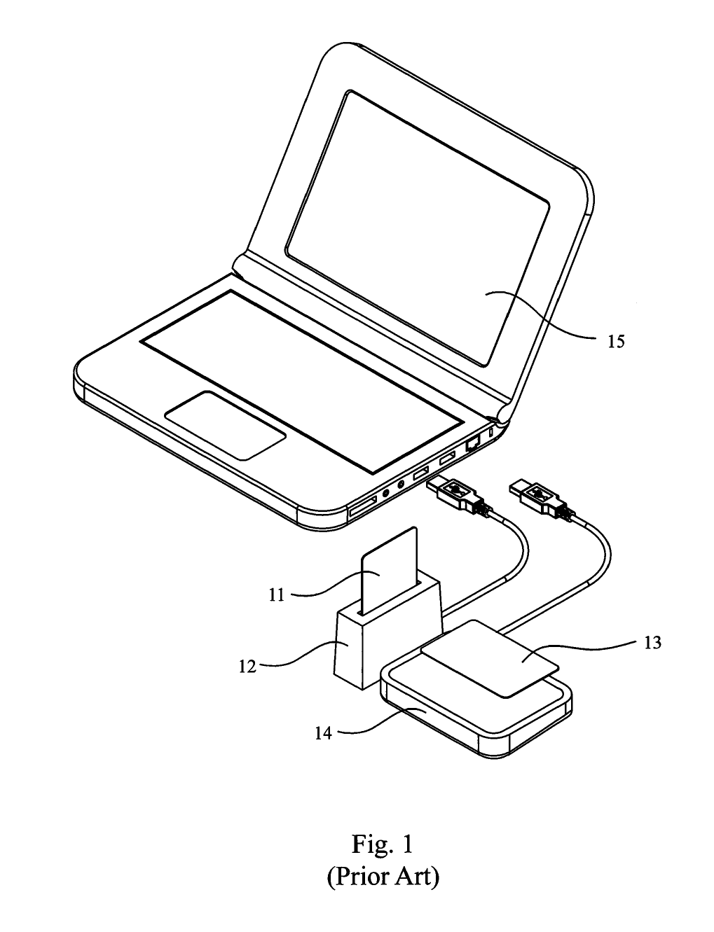

FIG. 2 illustrates a schematic diagram of using a card with a USB interface to trade over the Internet according to a first embodiment of the present invention.

FIG. 3 illustrates a schematic diagram of using a card with a USB interface to trade over the Internet according to a second embodiment of the present invention.

FIG. 4 is a schematic diagram to show the function of the back-end trade platform and the front-end trade platform.

### DETAILED DESCRIPTION

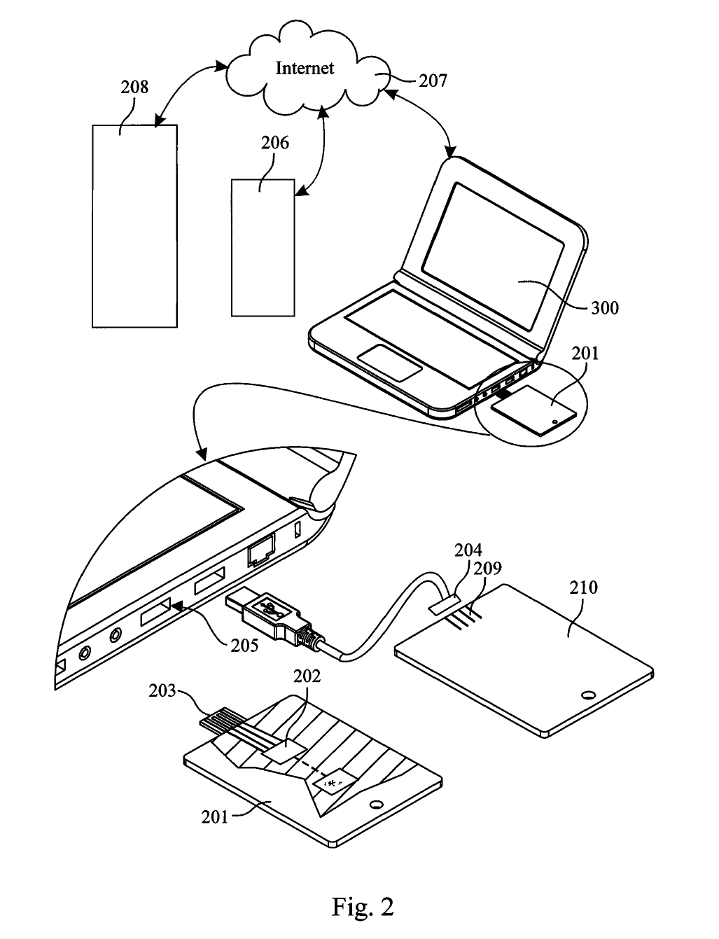

FIG. 2 illustrates a schematic diagram of using a card with a USB interface to trade over the Internet according to a first embodiment of the present invention. The first embodiment includes a card with a USB circuit, a USB interface, a USB port of computer, a USB wire, a front-end trade platform, the Internet and a back-end trade platform.

According to this embodiment, a USB circuit 202 and a USB interface 203 are embedded into a contact-type IC card 201. The USB interface 203 is inserted into the USB port 205 of a computer. In another embodiment, a USB wire 204 communicates through the USB interface 209 with the USB port 205 of a computer. A buyer can connect to a web-site through the Internet 207 to buy goods. When the buyer selects goods, the buyer can communicate with the back-end trade platform 208 of a bank through the front-end trade platform 206 of the web site and the Internet 207 to process a payment and identify the user.

In another embodiment, a USB wire 204 communicates with the USB interface 209 of a contactless type card with the USB port 205 of a computer. A buyer can connect with a web-site through the Internet 207 to buy goods. When the buyer selects goods, the buyer can communicate with the back-end trade platform 208 of a bank through the front-end trade platform 206 of the web site and the Internet 207 to process a payment and identify the user. In the first embodiment, a USB circuit and a USB interface are embedded in a card, such as a contact-type IC card or a contactless type IC card. Then, this card can directly communicate with a computer to process a trade on a web-site and through the front-end trade platform 206 of the web site and the Internet 207 to communicate with the back-end trade platform 208 of a bank to process a payment and identify the user. Therefore, the reading card machine is not necessary. Moreover, when a program for processing a small amount of money payment is embedded in the computer, the front-end trade platform 206 and the back-end trade platform 208, the complicated identification process to identify the buyer is removed and the card with a USB interface can communicate with a computer to realize a small amount of money payment process.

The USB interface 203 protrudes out the card and is inserted into a USB port 205 in a computer. In another embodiment, the USB interface 209 is formed in the card. A USB wire 204 is used to connect the card to the USB port of the computer. These two types of USB interface design can be applied in a contact type IC card and contactless type IC card. A user can select one of the two USB interfaces in the card based on his requirement.

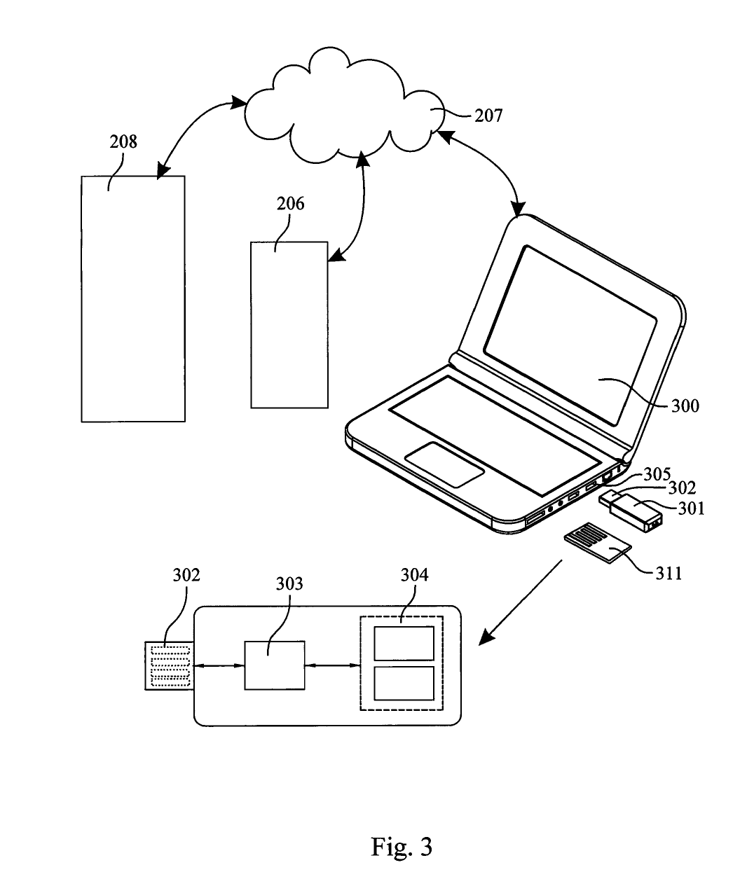

FIG. 3 illustrates a schematic diagram of using a card with a USB interface to trade over the Internet according to a second embodiment of the present invention. The second embodiment includes a shell 301, a USB interface 302 embedded in the shell 301, a USB transforming and control circuit 303, a memory logic gate 304, a USB port 305, an browser 300, a front-end trade platform 206, the Internet 207 and a back-end trade platform 208. A pre-paid card and a USB interface are included in the shell 301. The front-end trade platform 206 can deduct money from the pre-paid card and shows the remained money in a display. The back-end trade platform 208 manages the trade between a web-site and a buyer.

According to this embodiment, the USB interface 302 is inserted into the USB port 305 of a computer. A buyer can connect with a web-site through the Internet 207 and through his browser 300 to buy goods in this web-site. When the buyer selects goods, the buyer can communicate with the back-end trade platform 208 of a bank through the front-end trade platform 206 of the web site and the Internet 207 to process a payment and identify the user.

In another embodiment, a shell 311 has a PCB board type appearance is inserted into the USB port 305 of a computer. A buyer can connect with a web-site through the Internet 207 and through his browser 300 to buy goods in this web-site. When the buyer selects goods, the buyer can communicate with the back-end trade platform 208 of a bank through the front-end trade platform 206 of the web site and the Internet 207 to process a payment process and identification process.

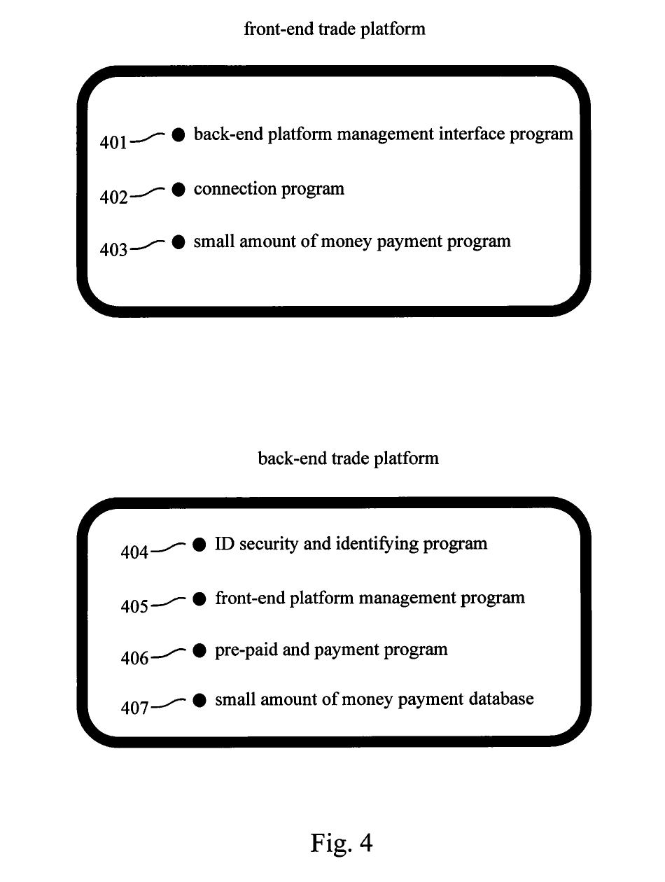

FIG. 4 is a schematic diagram to show the function of the back-end trade platform 208 and the front-end trade platform 206. The front-end trade platform 206 is built in the web-site. When a buyer selects goods through his browser, a small amount of money payment management program 403 is activated to deduct the money form the pre-paid card and through a connection program 402 and a back-end platform management interface 401 to show the money remaining on the pre-paid card and record this trade. The back-end trade platform 208 includes an ID security and identifying program 404, a pre-paid and payment program 406, a small amount of money payment database 407 and a front-end platform management interface 408. The back-end trade platform 208 and the front-end trade platform 206 can communicate with each other.

Although the present invention has been described in considerable detail with reference to certain embodiments thereof, other embodiments are possible.

Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A payment system for paying money over the Internet, comprising:
an IC card, wherein the IC card has a circuit for transforming a signal into a USB signal and a USB interface;
a USB port of a computer, wherein the USB interface of the IC card communicates with the USB port;
a front-end trade platform, the IC card communicates with the front-end trade platform through the computer and the Internet; and
a back-end trade platform, wherein the back-end trade platform has a program to perform a small amount of money payment process that does not perform an identification process to identify a holder of IC card.

2. The payment system of claim 1, wherein the USB interface is is protruded out the IC card to inserted into the USB port of the computer.

3. The payment system of claim 1, wherein the USB interface is formed in the IC card and a wire connects the USB interface to the USB port of the computer.

4. The payment system of claim 1, wherein the IC card is a contactless type Card, a contact type card or a combo-type card.

5. The payment system of claim 1, wherein the front-end trade platform does not perform an identification process to identify a holder of IC card.

6. The payment system of claim 1, wherein the front-end trade platform can communicate with the back-end trade platform.

7. A payment system for paying money in an Internet, comprising:
a USB interface;
a circuit for transforming a signal into a USB signal;
a pre-paid card, wherein the USB interface, the pre-paid card and the circuit are covered by a shell;
a USB port of a computer, wherein the USB interface of the IC card communicates with the USB port;
a front-end trade platform, the IC card communicates with the front-end trade platform through the computer and the Internet; and
a back-end trade platform, wherein the back-end trade platform has a is program to perform a small amount of money payment process that does not perform an identification process to identify a holder of IC card.

8. The payment system of claim 7, wherein the USB interface is a PCB board type.

9. The payment system of claim 7, wherein the front-end trade platform does not perform an identification process to identify a holder of IC card.

10. The payment system of claim 7, wherein the front-end trade platform can communicate with the back-end trade platform.
